(19) United States
(12) Patent Application Publication
(10) Pub. No.: US 2025/0119020 A1
(43) Pub. Date: Apr. 10, 2025

(54) INSULATOR, STATOR, ROTATING ELECTRIC MACHINE, AND METHOD FOR MANUFACTURING STATOR

(71) Applicant: Mitsubishi Electric Corporation, Chiyoda-ku, Tokyo (JP)

(72) Inventors: Ryo NABIKA, Chiyoda-ku, Tokyo (JP); Akiko TATEBE, Chiyoda-ku, Tokyo (JP); Takeshi YAGI, Chiyoda-ku, Tokyo (JP); Koki NAKA, Chiyoda-ku, Tokyo (JP)

(73) Assignee: Mitsubishi Electric Corporation, Chiyoda-ku, Tokyo (JP)

(21) Appl. No.: 18/725,943

(22) PCT Filed: Feb. 22, 2023
(86) PCT No.: PCT/JP2023/006350

§ 371 Date: Jul. 1, 2024

(30) Foreign Application Priority Data
Apr. 5, 2022 (JP) 2022-062876

(51) Int. Cl. H02K 3/52; H02K 15/022

(52) U.S. Cl. CPC H02K 3/522; H02K 15/022; H02K 2203/12

(57) ABSTRACT

A first connection portion and a second connection portion are structured by a snap-fit mechanism using elastic deformation. A pair of the insulators adjacent in the circumferential direction Z and connected via the first connection portion and the second connection portion are rotatable relative to each other about rotation center axes in an axial direction Y of the first connection portion and the second connection portion. The rotation center axes are located on an inner side in a radial direction relative to an outer-circumferential surface on an outer side in the radial direction of a divisional core.

### TECHNICAL FIELD

The present disclosure relates to an insulator, a stator, a rotating electric machine, and a method for manufacturing a stator.

### BACKGROUND ART

Among conventional stators of rotating electric machines, a stator formed such that core pieces divided on a tooth basis are joined to each other bendably in a direction perpendicular to an axis, is disclosed (see, for example, Patent Document 1 and Patent Document 2). Adjacent teeth in the stator are close to each other on the inner side in the radial direction. In the above configuration, an angle of a connection part is changed so that the teeth are located on the radially outer side, whereby a coil can be wound without interfering with an adjacent core piece and thus the space factor of the coil can be improved.

### CITATION LIST

### Patent Document

Patent Document 1: Japanese Laid-Open Patent Publication No. 2000-201458
Patent Document 2: Japanese Laid-Open Patent Publication No. 2006-254569

### SUMMARY OF THE INVENTION

### Problem to be Solved by the Invention

As a conventional example, in Patent Document 1, stacked steel sheets of adjacent core pieces are engaged with each other at a connection portion. Therefore, it is necessary to prepare two kinds of stacked steel sheets, and a punching swage is needed for connection, so that the kinds of members increase. Thus, the cost increases and the manufacturing process is complicated.

As another example, in Patent Document 2, a

mechanism for insertion/extraction in the axial direction is provided for connection and rotation. When teeth are directed outward, a retention mechanism and the like need to be prepared for preventing positional displacement in the axial direction after connection. Thus, a manufacturing apparatus is complicated, the cost thereof is high, and the manufacturing process is complicated.

The present disclosure has been made to solve the above problems, and an object of the present disclosure is to provide an insulator, a stator, a rotating electric machine, and a method for manufacturing a stator, which enable cost reduction and simplification of a manufacturing process.

### Means to Solve the Problem

An insulator according to the present disclosure is an insulator of a stator of a rotating electric machine in which a plurality of divisional-coil-wound bodies are arranged in an annular shape, the divisional-coil-wound bodies each including a divisional core, the insulator provided to the divisional core, and a coil wound around the divisional core with the insulator interposed therebetween, the insulator including: a first connection portion which is provided at one end in a circumferential direction on an outer side in a radial direction and which is to be connected to another said insulator adjacent in the circumferential direction; and a second connection portion which is provided at another end in the circumferential direction on the outer side in the radial direction and which is to be connected to the first connection portion of another said insulator adjacent in the circumferential direction. The first connection portion and the second connection portion are structured by a snap-fit mechanism using elastic deformation. A pair of the insulators adjacent in the circumferential direction and connected via the first connection portion and the second connection portion are rotatable relative to each other about rotation center axes in an axial direction of the first connection portion and the second connection portion. The rotation center axes are located on an inner side in the radial direction relative to an outer-circumferential surface on the outer side in the radial direction of the divisional core.

A stator according to the present disclosure is the stator having the above insulator. Each divisional core has a yoke portion extending in the circumferential direction and a tooth portion protruding toward the inner side in the radial direction from an inner-circumferential surface on the inner side in the radial direction of the yoke portion. One end in the circumferential direction of the yoke portion is formed in a convex shape. Another end in the circumferential direction of the yoke portion is formed in a concave shape. The convex shape and the concave shape have curved surfaces having the same radius of curvature.

A rotating electric machine according to the present disclosure includes: the above stator; and a rotor provided so as to be opposed to the stator with a gap in the radial direction therebetween.

A method for manufacturing a stator according to the present disclosure is a method for manufacturing the above stator, in which the first connection portions and the second connection portions of the divisional cores adjacent in the circumferential direction and provided with the insulators for a plural number not less than a number for forming the stator are connected, and then a magnet wire is continuously wound around the tooth portions with the insulators interposed therebetween by a flyer arm, to form the coils.

### Effect of the Invention

With the insulator, the stator, the rotating electric machine, and the method for manufacturing the stator according to the present disclosure, it becomes possible to provide an insulator, a stator, a rotating electric machine, and a method for manufacturing a stator, which enable cost reduction and simplification of a manufacturing process.

### BRIEF DESCRIPTION OF THE DRAWINGS

FIG. 1 is a plan view showing the structure of a divisional core according to embodiment 1.

FIG. 2 is a perspective view showing the structure of an insulator to be provided to the divisional core shown in FIG. 1.

FIG. 3 is a plan view showing the structure of the insulator shown in FIG. 2.

FIG. 4 is a bottom view showing the structure of the insulator shown in FIG. 2.

FIG. 5 is a perspective view showing a structure in which the insulators shown in FIG. 2 are provided to the divisional core shown in FIG. 1.

FIG. 6 is a perspective view showing a state when the insulators of the divisional cores shown in FIG. 5 are connected in the circumferential direction.

FIG. 7 is a plan view showing a state in which a coil is formed around the insulators of each divisional core shown in FIG. 6.

FIG. 8 is a plan view showing a state when a coil is formed around the insulators of each divisional core shown in FIG. 6.

FIG. 9 is a plan view showing a state when a coil is formed around the insulators of the divisional core shown in FIG. 5.

FIG. 10 is a plan view showing a structure in which divisional-coil-wound bodies formed through FIG. 7 to FIG. 9 are arranged in an annular shape.

FIG. 11 is an enlarged plan view showing a part of the divisional-coil-wound bodies arranged in an annular shape shown in FIG. 10.

FIG. 12 is a plan view showing a method for arranging the divisional-coil-wound bodies shown in FIG. 11 into an annular shape.

FIG. 13 is a perspective view showing the structure of a stator in which the divisional-coil-wound bodies arranged in an annular shape shown in FIG. 10 are covered by molding.

FIG. 14 is a sectional view showing the structure of a rotating electric machine having the stator shown in FIG. 13.

FIG. 15 is a sectional view showing the structure of the rotating electric machine having the divisional-coil-wound bodies arranged in an annular shape shown in FIG. 10.

FIG. 16 is a flowchart showing a method for forming the stator shown in FIG. 13 or FIG. 14.

FIG. 17 is a flowchart showing another method for forming the stator shown in FIG. 13 or FIG. 14.

FIG. 18 shows another method for forming the stator shown in FIG. 13 or FIG. 14.

FIG. 19 is a plan view showing the structure of a divisional core according to embodiment 2.

FIG. 20 is a perspective view showing the structure of an insulator to be provided to the divisional core shown in FIG. 19.

FIG. 21 is a perspective view showing a structure in which the insulators shown in FIG. 20 are provided to the divisional core shown in FIG. 19.

FIG. 22 is a perspective view showing a state when the insulators of the divisional cores shown in FIG. 21 are connected in the circumferential direction.

FIG. 23 is a plan view showing a state when a coil is formed around the insulators of each divisional core shown in FIG. 21.

FIG. 24 is a plan view showing a state when a coil is formed around the insulators of each divisional core shown in FIG. 21.

FIG. 25 is a plan view showing a state when a coil is formed around the insulators of the divisional core shown in FIG. 21.

FIG. 26 is a plan view showing a structure in which divisional-coil-wound bodies formed through FIG. 23 to FIG. 25 are arranged in an annular shape.

FIG. 27 is an enlarged plan view showing a part of the divisional-coil-wound bodies arranged in an annular shape shown in FIG. 26.

FIG. 28 is a perspective view showing the structure of an insulator to be provided to a divisional core according to embodiment 3.

FIG. 29 is a perspective view showing a state in which divisional-coil-wound bodies according to embodiment 3 are connected in the circumferential direction.

FIG. 30 is a perspective view showing a state in which the divisional-coil-wound bodies according to embodiment 3 are connected in the circumferential direction.

FIG. 31 is a perspective view showing the structure of another insulator to be provided to the divisional core according to embodiment 3.

FIG. 32 is a perspective view showing a state in which other divisional-coil-wound bodies according to embodiment 3 are connected in the circumferential direction.

FIG. 33 is a perspective view showing a state in which other divisional-coil-wound bodies according to embodiment 3 are connected in the circumferential direction.

FIG. 34 is a plan view showing the state of adjacent divisional cores in a comparative example.

### DESCRIPTION OF EMBODIMENTS

### Embodiment 1

In the following description, directions with respect to a rotating electric machine 100 are defined as an axial direction Y, a circumferential direction Z, and a radial direction X. The axial direction Y is a direction parallel to a shaft 13 (output shaft) of the rotating electric machine 100, the circumferential direction Z is a rotation direction of the rotating electric machine 100, and the radial direction X is a radial direction of the rotating electric machine 100. In addition, an outer side in the radial direction X is denoted by X1, and an inner side in the radial direction X is denoted by X2. Accordingly, other parts composing the rotating electric machine 100 are also described with reference to the above directions. Also in other embodiments, the above directions apply in the same manner.

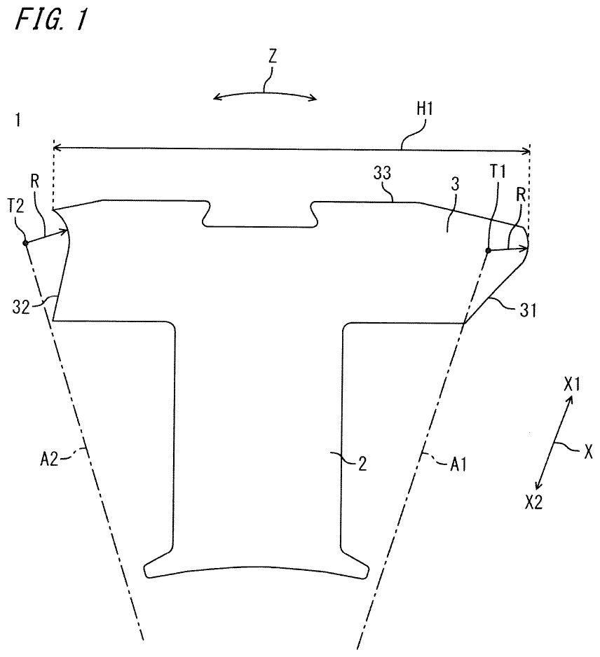

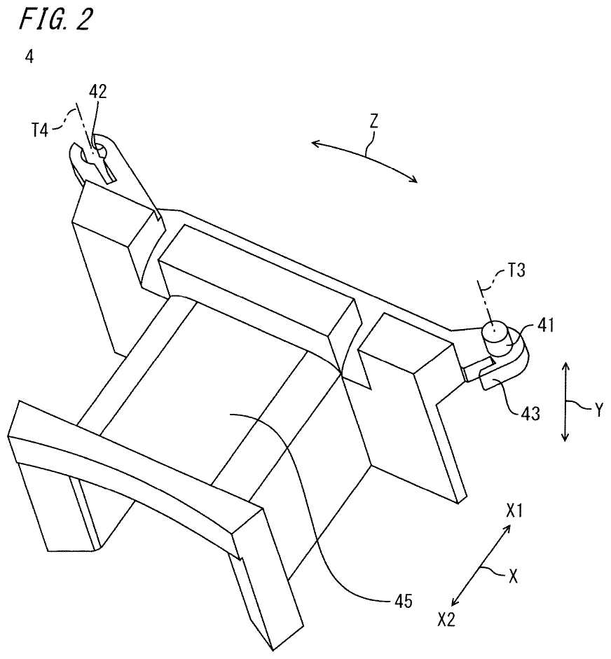

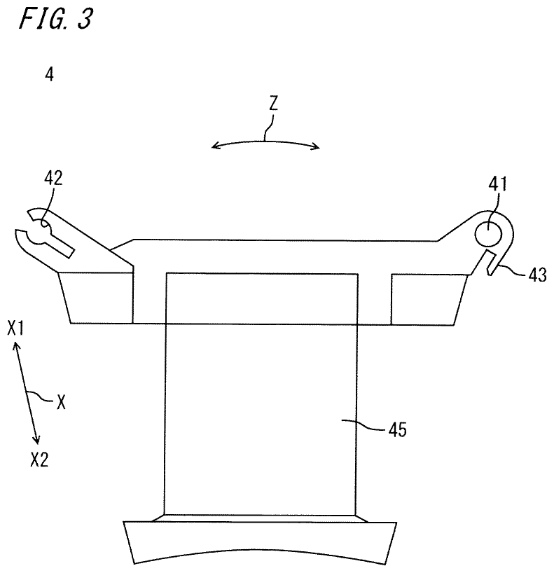

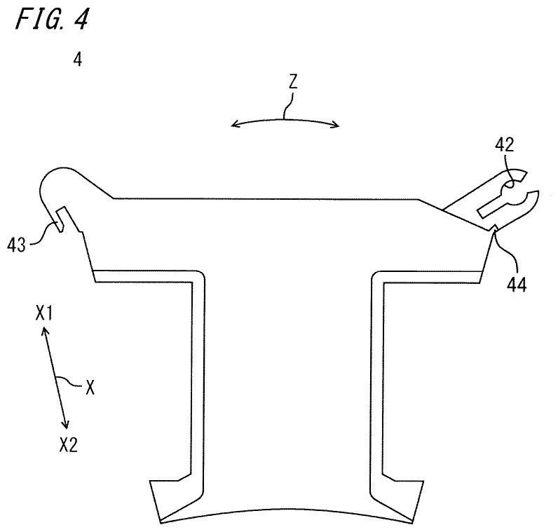

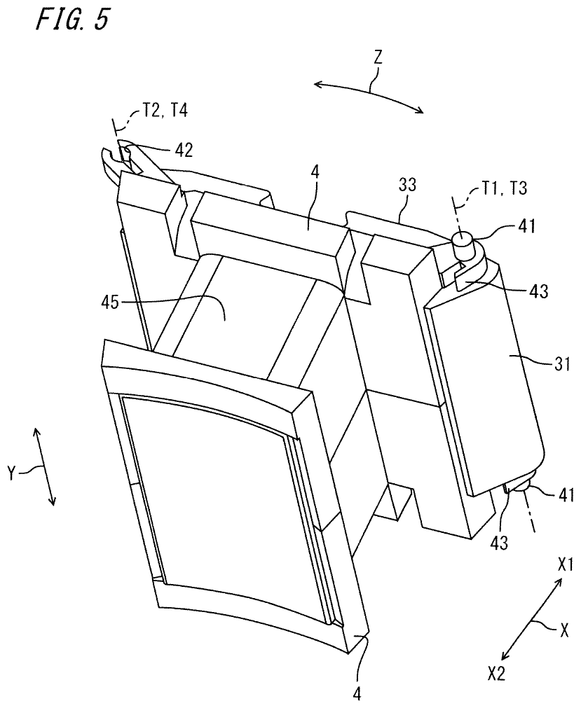

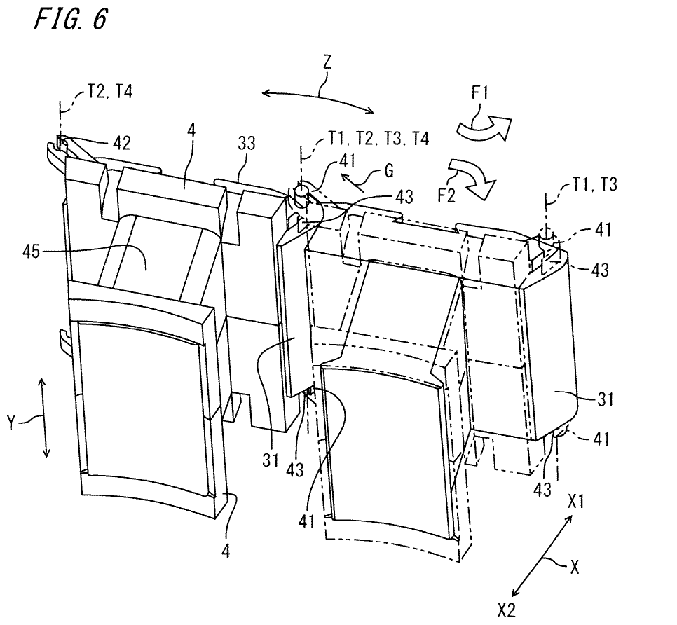

FIG. 1 is a plan view showing the structure of a divisional core according to embodiment 1. FIG. 2 is a perspective view showing the structure of an insulator to be provided to the divisional core shown in FIG. 1. FIG. 3 is a plan view showing the structure of the insulator shown in FIG. 2. FIG. 4 is a bottom view showing the structure of the insulator shown in FIG. 2. FIG. 5 is a perspective view showing a structure in which the insulator shown in FIG. 2 is provided to the divisional core shown in FIG. 1. FIG. 6 is a perspective view showing a state when the insulators of the divisional cores shown in FIG. 5 are connected in the circumferential direction.

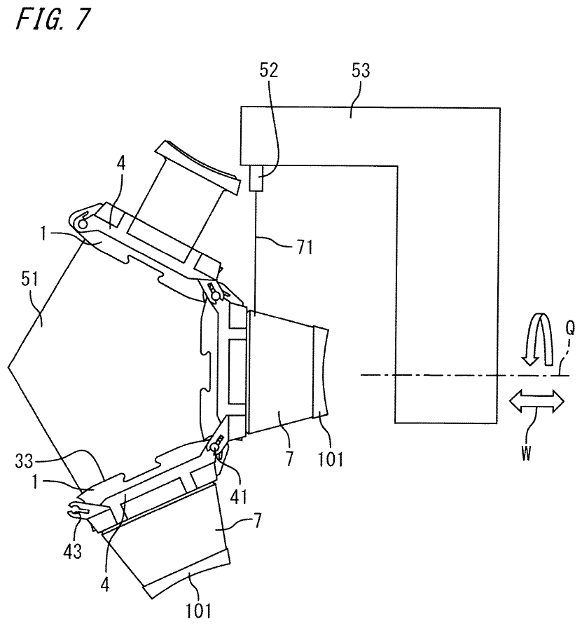

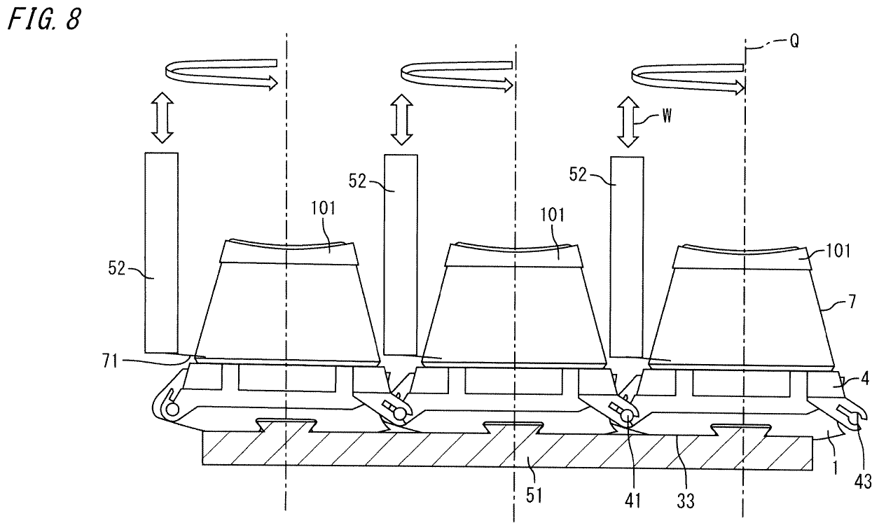

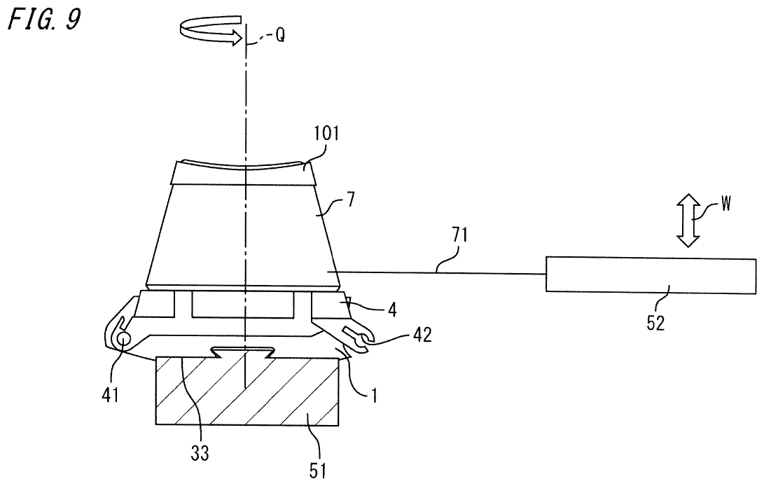

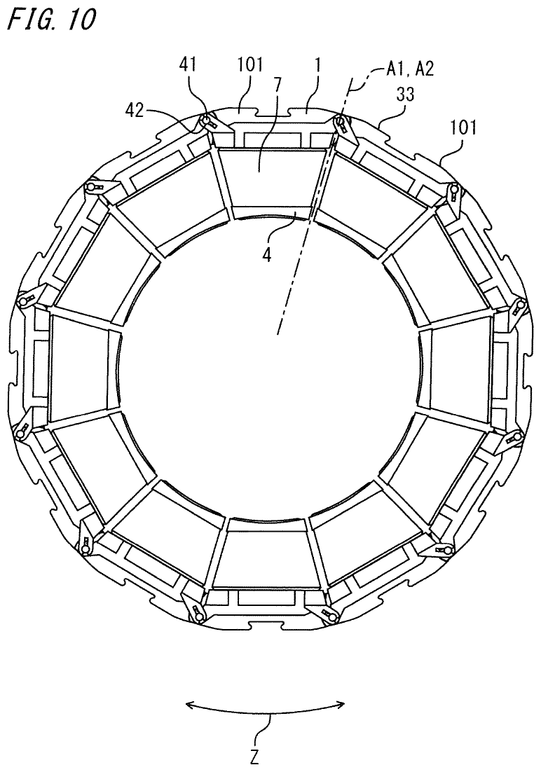

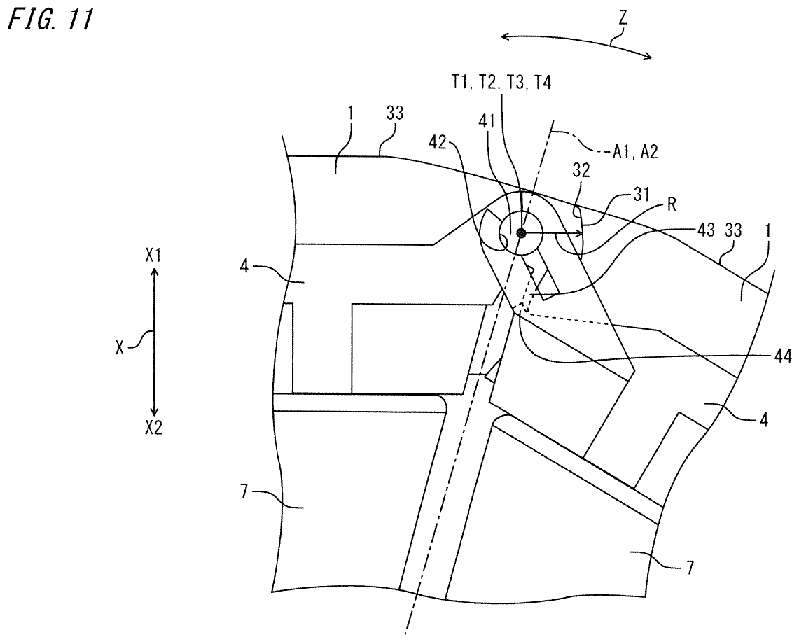

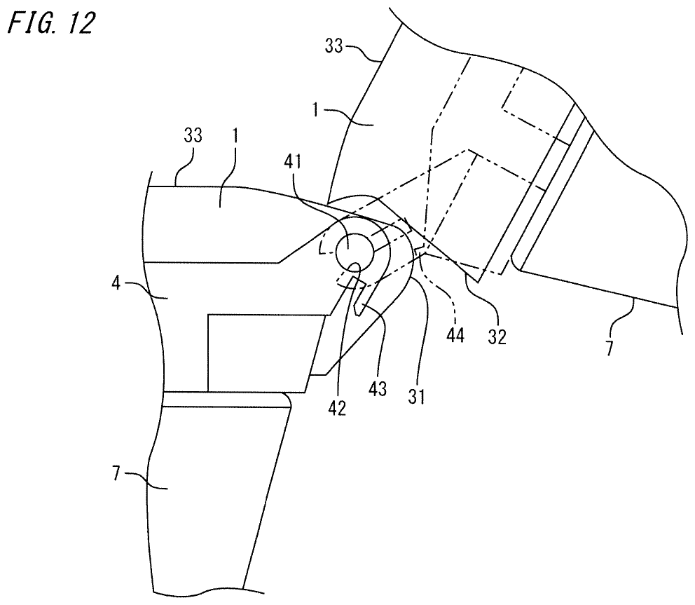

FIG. 7 is a plan view showing a state when a coil is formed around the insulators of each divisional core shown in FIG. 6. FIG. 8 is a plan view showing a state when a coil is formed around the insulators of each divisional core shown in FIG. 6. FIG. 9 is a plan view showing a state when a coil is formed around the insulators of the divisional core shown in FIG. 5. FIG. 10 is a plan view showing a structure in which divisional-coil-wound bodies formed through FIG. 7 to FIG. 9 are arranged in an annular shape. In the present disclosure, the annular shape is a circular ring shape, as an example. FIG. 11 is an enlarged plan view of a part of the divisional-coil-wound bodies arranged in an annular shape shown in FIG. 10. FIG. 12 is a plan view showing a method for arranging the divisional-coil-wound bodies shown in FIG. 11 into an annular shape.

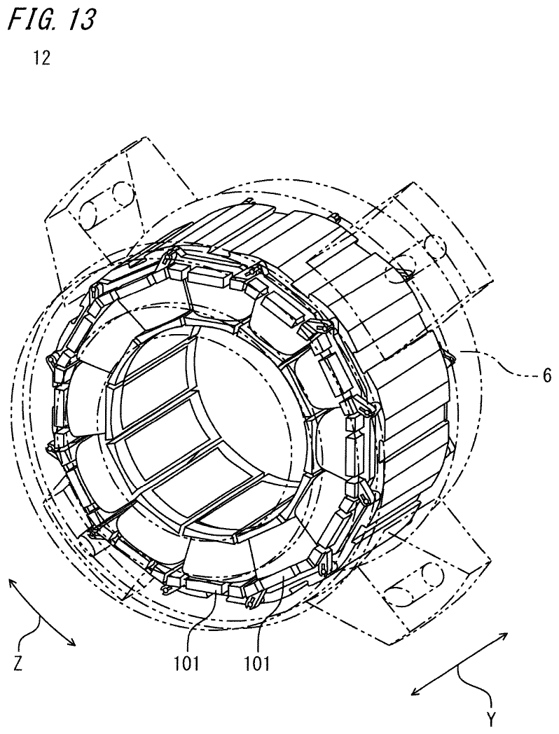

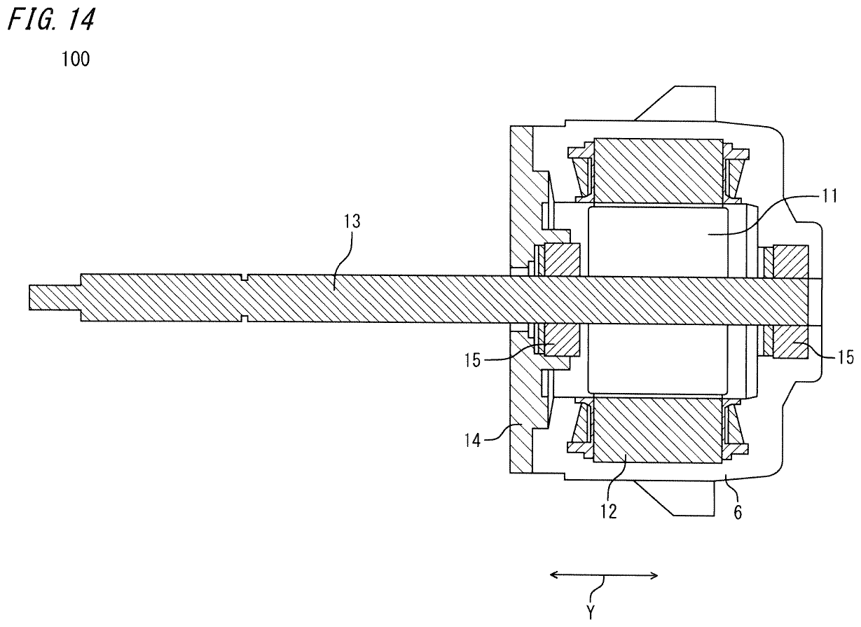

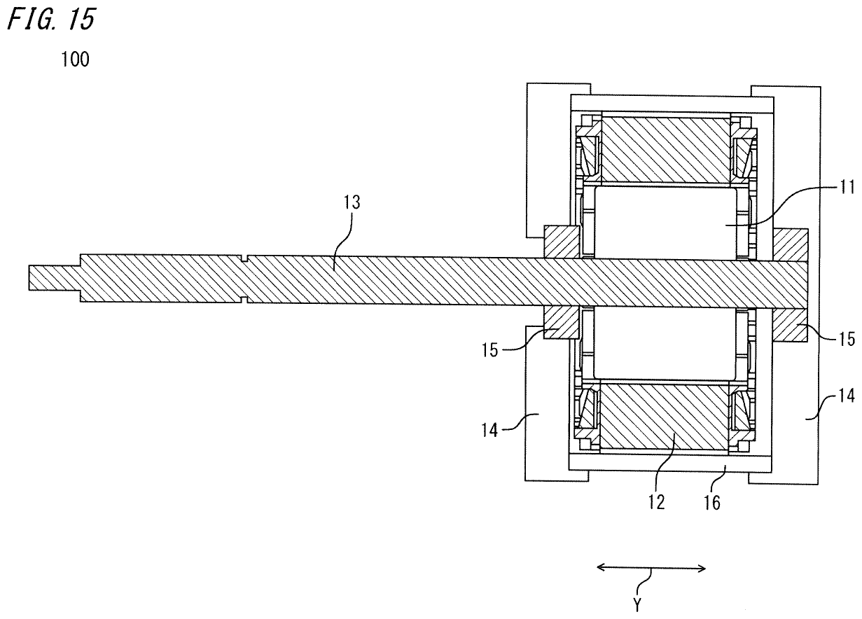

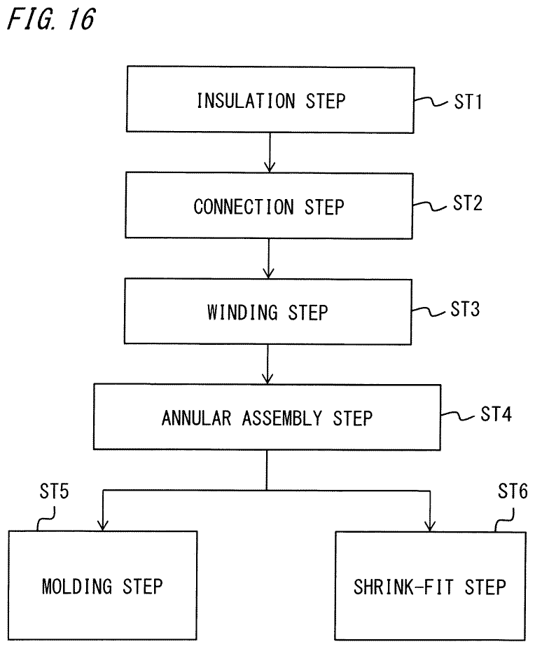

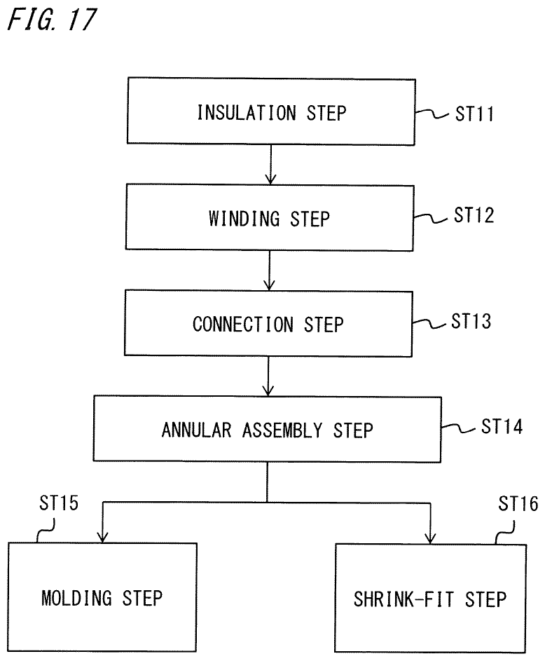

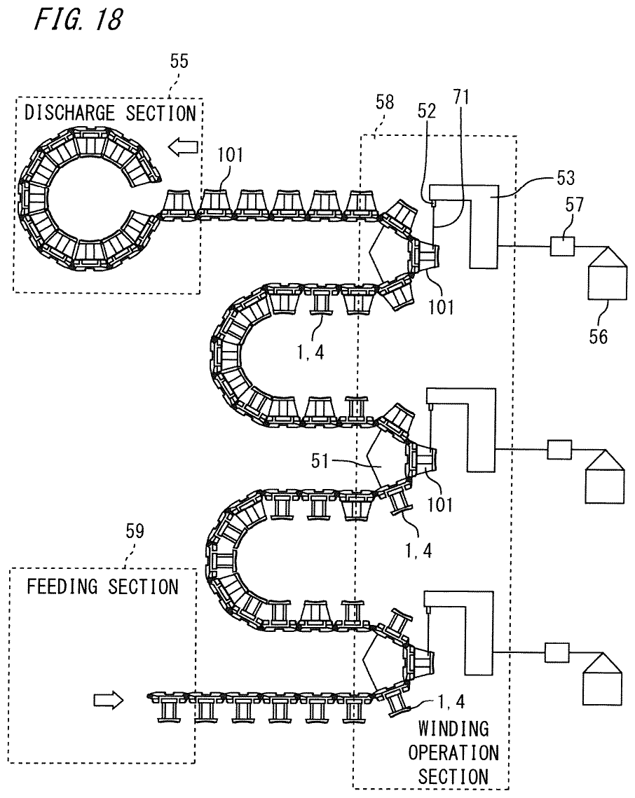

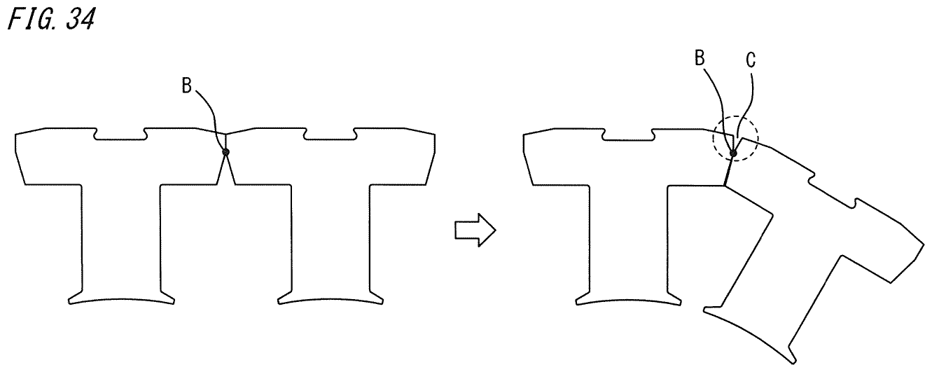

FIG. 13 is a perspective view showing the structure of a stator in which the divisional-coil-wound bodies arranged in an annular shape shown in FIG. 10 are covered by molding. FIG. 14 is a sectional view showing the structure of a rotating electric machine having the stator shown in FIG. 13. FIG. 15 is a sectional view showing the structure of the rotating electric machine having the divisional-coil-wound bodies arranged in an annular shape shown in FIG. 10. FIG. 16 is a flowchart showing a method for forming the stator shown in FIG. 13 or FIG. 14. FIG. 17 is a flowchart showing another method for forming the stator shown in FIG. 13 or FIG. 14. FIG. 18 shows another method for forming the stator shown in FIG. 13 or FIG. 14. FIG. 34 is a plan view showing the state of adjacent divisional cores in a comparative example.

First, the structure of a divisional core 1 will be described with reference to FIG. 1. FIG. 1 is a plan view showing the structure of the divisional core 1. In FIG. 1, the divisional core 1 is each of divisional cores composing an annular-shaped stator 12 of a rotating electric machine 100 (see FIG. 14) of an inner-rotor type and divided in the circumferential direction Z correspondingly to the number of slots. The divisional core 1 has a yoke portion 3 extending in the circumferential direction Z, and a tooth portion 2 protruding toward the inner side X2 in the radial direction X from an inner-circumferential surface on the inner side X2 in the radial direction X of the yoke portion 3.

The yoke portion 3 of the divisional core 1 has, at one end in the circumferential direction Z, a first contact portion 31 as a circumferential-direction end surface to abut on another divisional core 1 adjacent on one side in the circumferential direction Z. The yoke portion 3 of the divisional core 1 has, at another end in the circumferential direction Z, a second contact portion 32 as a circumferential-direction end surface to abut on another divisional core 1 adjacent on another side in the circumferential direction Z. The first contact portion 31 and the second contact portion 32 are each formed in a surface shape obtained by combining a curved surface and a flat surface. The first contact portion 31 is formed in a convex shape protruding in the circumferential direction Z.

The second contact portion 32 is formed in a concave shape recessed in the circumferential direction Z.

Curved-surface parts of the first contact portion 31 and the second contact portion 32 are formed with a radius R of curvature. A center axis in the axial direction Y of the radius R of curvature of the first contact portion 31 is defined as a first center axis T1, and a center axis in the axial direction Y of the radius R of curvature of the second contact portion 32 is defined as a second center axis T2. The first center axis T1 and the second center axis T2 are respectively formed on a first virtual plane A1 and a second virtual plane A2 each extending in the axial direction Y at the middle in the circumferential direction Z between a pair of divisional cores 1 adjacent in the circumferential direction Z.

Then, when a plurality of divisional cores 1 are combined in an annular shape, the first center axis T1 of one of the divisional cores 1 adjacent in the circumferential direction Z and the second center axis T2 of the other divisional core 1 coincide with each other. When the annular-shaped stator 12 is assembled, the shape of the first contact portion 31 of one divisional core 1 is fitted along the shape of the second contact portion 32 of the other divisional core 1 adjacent in the circumferential direction Z.

The first center axis T1 and the second center axis T2 are formed at positions on the inner side X2 in the radial direction X relative to the outer-circumferential surface 33 in the radial direction X of the divisional core 1. Thus, a thickness for a mold resin portion 6 (see FIG. 13 and FIG. 14) described later can be ensured, or interference with a shrink-fit frame 16 (see FIG. 15) can be prevented. The divisional cores 1 have no means for joining and retaining themselves to each other alone. Thus, since the divisional core 1 has a simple shape, it suffices that one kind of mold is prepared for the divisional core 1, so that the divisional core 1 can be easily manufactured and the cost thereof is reduced.

Next, the structure of the insulator 4 will be described with reference to FIG. 2 to FIG. 4. FIG. 2 is a perspective view showing the structure of the insulator 4. FIG. 3 is a plan view showing the structure of the insulator 4 shown in FIG. 2, as seen from the upper side of the drawing sheet. FIG. 4 is a plan view showing the structure of the insulator 4 shown in FIG. 2, as seen from the back side of the drawing sheet. In the drawings, the insulator 4 is to be attached by being fitted to the divisional core 1 so as to make insulation between the divisional core 1 and a coil 7 (see FIG. 7) to be wound in a later process, and therefore is formed in a shape along the tooth portion 2 of the divisional core 1. The insulator 4 has a winding portion 45 around which the coil 7 is wound.

The insulator 4 is made of an insulating material having a low elastic modulus, such as resin. A columnar portion 41 as a first connection portion is formed at one end in the circumferential direction Z on the outer side X1 in the radial direction X of the insulator 4. An opening 42 as a second connection portion to be connected to the columnar portion 41 as the first connection portion of another insulator 4 adjacent in the circumferential direction Z is formed at another end in the circumferential direction Z on the outer side X1 in the radial direction X. The columnar portion 41 and the opening 42 are structured by a snap-fit mechanism using elastic deformation. The columnar portion 41 and the opening 42 are formed with such dimensions that maximum strain in engagement by the snap-fit mechanism does not exceed breaking strain.

The columnar portion 41 and the opening 42 are rotatable in an engaged state, and as rotation-center axes thereof, the columnar portion 41 has a first rotation-center axis T3 and the opening 42 has a second rotation-center axis T4, as shown in FIG. 2. The first rotation-center axis T3 is set so as to coincide with the first center axis T1 of the divisional core 1 shown in FIG. 1, and the second rotation-center axis T4 is set so as to coincide with the second center axis T2 of the divisional core 1 shown in FIG. 1. A claw-shaped first barb portion 43 is formed at a base part of the columnar portion 41. A second barb portion 44 is formed at a base part of the opening 42, as shown in FIG. 4. When the divisional cores 1 are combined in an annular shape, the first barb portion 43 and the second barb portion 44 are caught on each other, thus improving the retention strength in the annular assembled state.

Next, a structure in which the insulators 4 are attached to the divisional core 1 will be described. FIG. 5 is a perspective view showing a state in which the insulators 4 are attached to both ends in the axial direction Y of the divisional core 1. As shown in FIG. 5, when the insulators 4 are attached to the divisional core 1, the first rotation-center axis T3 of the columnar portions 41 of the insulators 4 at both ends in the axial direction Y is located coaxially with the first center axis T1 of the divisional core 1, and the second rotation-center axis T4 of the openings 42 is located coaxially with the second center axis T2. Therefore, the rotation center axes T3 and T4 are located on the inner side X2 in the radial direction X relative to the outer-circumferential surface 33 on the outer side X1 in the radial direction X of the divisional core 1.

The first rotation-center axis T3 is located on the inner side in the circumferential direction Z (at a position shifted toward the center side in the circumferential direction Z of the tooth portion 2 and overlapping the divisional core 1 as seen in the axial direction Y) relative to the circumferential-direction end surface (first contact portion 31) of the divisional core 1. The second rotation-center axis T4 is located on the outer side in the circumferential direction Z relative to the circumferential-direction end surface (second contact portion 32) of the divisional core 1. The circumferential-direction end surface (first contact portion 31) of the divisional core 1 on the first rotation-center axis T3 side is formed as an arc surface about the first rotation-center axis T3, on the outer side X1 in the radial direction X relative to the first rotation-center axis T3, i.e., in a range to the outer-circumferential surface 33 of the divisional core 1. The circumferential-direction end surface (second contact portion 32) of the divisional core 1 on the second rotation-center axis T4 side is formed as an arc surface recessed along the above arc surface. Thus, when the divisional cores 1 are arranged in an annular shape, the circumferential-direction end surfaces (first contact portion 31 and second contact portion 32) of the divisional cores 1 on the outer side X1 in the radial direction X relative to the respective rotation center axes T3 and T4 can contact with each other without forming any gaps, whereby a magnetic path is ensured and occurrence of magnetic saturation can be suppressed.

As shown in adjacent divisional cores in a comparative example in FIG. 34, if a rotation-center axis B is not sufficiently inward of circumferential-direction end surfaces of the divisional cores, a gap C is formed when the divisional cores are arranged in an annular shape. Therefore, divisional core parts on the outer side in the radial direction of the rotation-center axis B need to be reduced in thickness, so that a path for a magnetic flux (magnetic path) is decreased.

In the present embodiment 1, the insulator 4 on the upper side of the drawing sheet in the axial direction Y has the shape shown in FIG. 2 to FIG. 4, and the insulator 4 on the lower side of the drawing sheet in the axial direction Y has a shape mirror-symmetric with the insulator 4 on the upper side of the drawing sheet in the axial direction Y. This is merely an example, and the insulators 4 at both ends in the axial direction Y may have the same shape.

Next, a structure in which two divisional cores 1 with the insulators 4 attached thereto as shown in FIG. 5 are arranged in the circumferential direction Z, will be described with reference to FIG. 6. As shown in FIG. 6, two divisional cores 1 with the insulators 4 attached thereto are arranged in the circumferential direction Z, and the columnar portion 41 of one insulator 4 and the opening 42 of the other insulator 4 are fitted to each other by the snap-fit mechanism, so as to be connected. The columnar portion 41 is inserted into the opening 42 in a direction perpendicular to the first center axis T1, i.e., in a direction of arrow G, whereby the opening 42 is elastically deformed by the snap-fit mechanism, so that the columnar portion 41 and the opening 42 of the insulators 4 are engaged with each other at a position coaxial with the first rotation-center axis T3 and the second rotation-center axis T4.

With this engagement, each of the divisional cores 1 adjacent in the circumferential direction Z is rotatable in a direction F1 in which the tooth portions 2 are opened and a direction F2 in which the tooth portions 2 are closed (a direction to form an annular shape as shown in FIG. 10) around the first rotation-center axis T3 relative to the other divisional core 1. The first contact portion 31 and the second contact portion 32 respectively provided at both ends in the circumferential direction Z of the divisional core 1 have curved surfaces having the same radius R of curvature about the first center axis T1 and the second center axis T2 which are coaxial with the first rotation-center axis T3 and the second rotation-center axis T4. Therefore, the divisional cores 1 do not hinder rotation of the insulators 4.

Next, a method for forming the coil 7 by winding a magnet wire 71 around each of the divisional cores 1 connected in the circumferential direction Z as shown in FIG. 6 will be described with reference to FIG. 7. FIG. 7 shows a state in which the divisional cores 1 are rotated about the first rotation center axes T3 in the direction F1 (shown in FIG. 6) in which the divisional cores 1 are opened. Then, the outer-circumferential surfaces 33 of the divisional cores 1 are retained by a chuck portion 51. Next, the magnet wire 71 is supplied through a nozzle 52 from a flyer arm 53 provided at a position opposed to the tooth portion 2 of the divisional core 1 around which the magnet wire 71 is to be wound, and the flyer arm 53 is rotated about a rotation axis Q, thereby winding the magnet wire 71 around the tooth portion 2 of the divisional core 1 with the insulators 4 interposed therebetween, to form the coil 7. Thus, divisional-coil-wound bodies 101 connected in the circumferential direction Z are formed.

At this time, the tooth portions 2 of the divisional cores 1 which are adjacent in the circumferential direction Z and for which winding is not being performed, need to be moved away to the outside of the rotation trajectory range of the flyer arm 53. Therefore, as shown in FIG. 7, the tooth portions 2 of the divisional cores 1 adjacent in the circumferential direction Z are moved away to the outer sides of the insulator 4 of the tooth portion 2 for which winding is being performed. Thus, the flyer arm 53 can be swung in a swing direction W to the drawing-sheet left side (back side) of the tooth portion 2, whereby the coil 7 can be stored in a winding space without waste. Thus, the size of the stator 12 can be reduced.

In FIG. 7, for convenience of description, three divisional cores 1, i.e., one divisional core 1 for which winding is being performed and two divisional cores 1 adjacent on both sides in the circumferential direction Z, are shown. However, depending on the manufacturing method, only one or two divisional cores 1 may be retained by the chuck portion 51, or more divisional cores 1 may be continuously connected to the above three divisional cores 1, to be supplied with a wire.

A method different from the above method for forming the coil 7 shown in FIG. 7 will be described with reference to FIG. 8. FIG. 8 shows a method for forming the coil 7 by winding the magnet wire 71 around each of the divisional cores 1 connected in the circumferential direction Z as shown in FIG. 6. As shown in FIG. 8, in a state in which the divisional cores 1 connected in the circumferential direction Z are arranged straight, the outer-circumferential surfaces 33 of the divisional cores 1 are retained by the chuck portion 51, and the magnet wire 71 is supplied in an approximately orthogonal direction from the nozzle 52 revolving about the rotation axis Q around the tooth portion 2 of each divisional core 1 while passing through a rectangular or elliptic trajectory in a state of opposing the tooth portion 2 of the divisional core 1. Thus, the magnet wire 71 is supplied and wound by the nozzle 52 swinging in the swing direction W, to form the coil 7, whereby the divisional-coil-wound bodies 101 connected in the circumferential direction Z are formed.

In FIG. 8, a case where the magnet wires 71 are wound around three divisional cores 1 connected in the circumferential direction Z is shown. However, the magnet wires 71 may be wound around two, four, or more of the divisional cores 1 retained by the chuck portion 51, and the number (=the number of nozzles 52) of the divisional cores 1 around which the magnet wires 71 are wound at the same time may be one, two, four, or more.

A method different from the above methods for forming the coil 7 shown in FIG. 7 and FIG. 8 will be described with reference to FIG. 9. FIG. 9 shows a method for forming the coil 7 by winding the magnet wire 71 around the divisional core 1 before connection in the circumferential direction Z as shown in FIG. 5. As shown in FIG. 9, the outer-circumferential surface 33 of a single divisional core 1 is retained by the chuck portion 51. Then, the chuck portion 51 rotates the divisional core 1 about the rotation axis Q, and the magnet wire 71 is supplied and wound by the nozzle 52 swinging in the swing direction W, to form the coil 7, whereby the divisional-coil-wound body 101 not connected in the circumferential direction Z is formed.

Next, a structure in which the divisional-coil-wound bodies 101 are assembled in an annular shape will be described with reference to FIG. 10 to FIG. 12. In FIG. 10, the number of slots is 12, as an example. However, without limitation thereto, assembly can be performed in the same manner even in a case of having a different number of slots, e.g., 9 slots. FIG. 11 shows an enlarged view of one part among the first rotation center axes T3 in FIG. 10. FIG. 12 shows the same part as in FIG. 11, in a state of being rotated in a direction in which the tooth portions 2 are opened.

As described above, as shown in FIG. 11, the center axes T1 and T2 and the rotation center axes T3 and T4 are respectively located on the virtual planes A1 and A2 between the divisional cores 1 adjacent in the circumferential direction Z, and the first contact portion 31 and the second contact portion 32 provided at both ends in the circumferential direction Z of the divisional core 1 have curved surfaces having the same radius R of curvature about the first center axis T1 and the second center axis T2 which are coaxial with the first rotation-center axis T3 and the second rotation-center axis T4. Therefore, the divisional-coil-wound bodies 101 with the coils 7 formed thereon are rotatable about the first rotation-center axis T3, and the divisional-coil-wound bodies 101 adjacent in the circumferential direction Z closely contact with each other at the first contact portion 31 and the second contact portion 32 in the circumferential direction Z. In addition, since the yoke portion 3 of the divisional core 1 has, at both ends in the circumferential direction Z, the first contact portion 31 having a convex shape and the second contact portion 32 having a concave shape along the first contact portion 31, a sectional area of a path for a magnetic flux can be ensured sufficiently and the size of the stator 12 can be reduced.

When the tooth portions 2 are closed from the state shown in FIG. 12 into an annular shape as shown in the state shown in FIG. 11, the first barb portion 43 structured by a snap-fit mechanism elastically deforms in the direction in which the tooth portions 2 are closed, and the second barb portion 44 passes thereon. Then, from the state in which the tooth portions 2 are closed once, the second barb portion 44 is caught on the first barb portion 43, so that the tooth portions 2 are prevented from being easily opened. Although the first barb portion 43 is elastically deformable in the drawings, the second barb portion 44 may be elastically deformable instead of the first barb portion 43, or both of the first barb portion 43 and the second barb portion 44 may be elastically deformable.

Next, a structure in which the divisional-coil-wound bodies 101 assembled in an annular shape are covered by molding to form the stator 12 will be described. FIG. 13 shows a structure in which the divisional-coil-wound bodies 101 assembled in an annular shape as shown in FIG. 10 are covered by molding with resin. In FIG. 13, the divisional-coil-wound bodies 101 are retained by the mold resin portion 6. Therefore, it suffices that a connection force between the columnar portion 41 and the opening 42 of the insulators 4 withstands conveyance until the molding process. The divisional-coil-wound bodies 101 (the outer-circumferential surfaces 33 of the divisional cores 1) are fitted along a mold by a resin molding pressure, whereby precision of the inner diameter of the stator 12 can be ensured. Since the columnar portion 41 and the opening 42 (first connection portion and second connection portion) of the insulator 4 are located on the inner side X2 in the radial direction X relative to the outer-circumferential surface 33 of the divisional core 1, the thickness of the mold resin portion 6 is ensured so that resin can readily flow in molding.

Next, the structure of the rotating electric machine 100 having the stator 12 covered by molding will be described with reference to FIG. 14. In a bracket 14, a rotor 11 is attached to a shaft 13 via bearings 15, and the stator 12 having the mold resin portion 6 is placed on the outer circumferential side of the rotor 11 with a gap therebetween, thus forming the rotating electric machine 100.

The structure of the rotating electric machine 100 having the divisional-coil-wound bodies 101 assembled in an annular shape as shown in FIG. 10 which are not covered by molding, will be described with reference to FIG. 15. The divisional-coil-wound bodies 101 assembled in an annular shape are press-fitted or shrink-fitted to a cylindrical frame 16, thus forming the stator 12. Here, since the columnar portion 41 and the opening 42 (first connection portion and second connection portion) of the insulator 4 are located on the inner side X2 in the radial direction X relative to the outer-circumferential surface 33 of the divisional core 1, press-fit or shrink-fit can be performed with the frame 16 having a simple cylindrical shape, and thus a simple assembly method can be selected. By a preload due to an interference of press-fit or shrink-fit, the divisional-coil-wound bodies 101 contact with each other uniformly, whereby the roundness of the inner circumference can be ensured. The other structures are formed in the same manner as in FIG. 14 described above.

Next, a method for manufacturing the stator according to embodiment 1 configured as described above will be described. First, a case of using the method for forming the coil 7 as shown in FIG. 7 or FIG. 8 will be described with reference to a flowchart in FIG. 16. First, the insulator 4 is attached to the divisional core 1 as shown in FIG. 5, i.e., an insulation step is performed (step ST1 in FIG. 16). Next, the columnar portion 41 of the insulator 4 of the divisional core 1 and the opening 42 of the divisional core 1 adjacent thereto in circumferential direction Z (first connection portion and second connection portion) are engaged by a snap-fit mechanism, i.e., a connection step is performed (step ST2 in FIG. 16).

Next, as shown in FIG. 7 or FIG. 8, the magnet wire 71 is wound around the divisional core 1 with the insulators 4 interposed therebetween so as to form the coil 7, thus forming the divisional-coil-wound body 101, i.e., a winding step is performed (step ST3 in FIG. 16). Next, the divisional-coil-wound bodies 101 connected in the circumferential direction Z are assembled in an annular shape as shown in FIG. 10 (step ST4 in FIG. 16). Next, the divisional-coil-wound bodies 101 in an annular shape are covered with the mold resin portion 6 as shown in FIG. 13, thus forming the stator 12 (step ST5 in FIG. 16). Alternatively, the frame 16 as shown in FIG. 15 is shrink-fitted to the divisional-coil-wound bodies 101 in an annular shape as shown in FIG. 10, thus forming the stator 12 (step ST6 in FIG. 16).

Next, a case of using the method for forming the coil 7 as shown in FIG. 9 will be described with reference to a flowchart in FIG. 17. First, the insulator 4 is attached to the divisional core 1 as shown in FIG. 5, i.e., an insulation step is performed (step ST11 in FIG. 17). Next, as shown in FIG. 9, the magnet wire 71 is wound around a single divisional core 1 with the insulators 4 interposed therebetween so as to form the coil 7, thus forming the divisional-coil-wound body 101, i.e., a winding step is performed (step ST12 in FIG. 17). Next, the columnar portion 41 of the insulator 4 of the divisional-coil-wound body 101 and the opening 42 of the insulator 4 of the divisional-coil-wound body 101 adjacent thereto in the circumferential direction Z (first connection portion and second connection portion) are engaged by a snap-fit mechanism, i.e., a connection step is performed (step ST13 in FIG. 17).

Next, the divisional-coil-wound bodies 101 connected in the circumferential direction Z are assembled in an annular shape as shown in FIG. 10 (step ST14 in FIG. 17). Next, the divisional-coil-wound bodies 101 in an annular shape are covered with the mold resin portion 6 as shown in FIG. 13, thus forming the stator 12 (step ST15 in FIG. 17). Alternatively, the frame 16 as shown in FIG. 15 is shrink-fitted to the divisional-coil-wound bodies 101 in an annular shape as shown in FIG. 10, thus forming the stator 12 (step ST16 in FIG. 17).

In the cases of using the methods for forming the coil 7 as shown in FIG. 7 and FIG. 8, the process flow shown in FIG. 16 is performed and production efficiency is enhanced. On the other hand, in the case of using the method for forming the coil 7 as shown in FIG. 9, a space for the manufacturing line can be ensured and a winding apparatus can be simplified, and manufacturing can be performed through the process flow shown in FIG. 17.

Next, a method for forming the coil 7 by winding the magnet wire 71 more efficiently will be described with reference to FIG. 18. FIG. 18 shows an example in which three-phase windings are provided to the stator 12 having twelve slots. First, the divisional cores 1 whose number is larger than that for one stator 12 are connected via the columnar portions 41 and the openings 42 (first connection portions and second connection portions) of the insulator 4, and the divisional cores 1 are fed from a feeding section 59 to a winding operation section 58. Then, the magnet wire 71 is wound continuously by the flyer arm 53. The magnet wire 71 is taken out from a wire bobbin 56 storing the magnet wire 71, curl of the magnet wire 71 is straightened by a tensioner 57, and then the magnet wire 71 is supplied to the nozzle 52 of the flyer arm 53.

The flyer arms 53 are arranged for the number of phases of the stator 12, here, three phases, and at the winding operation section 58 including the flyer arms 53, only winding of the coils 7, routing operation for jumper wires between the coils 7, and ON/OFF operation for the chuck portion 51 for the divisional core 1 around which the magnet wire 71 is to be wound, are performed. Cutting of the magnet wire 71 is performed at a discharge section 55. Therefore, cutting of the magnet wire 71 can be excluded from a cycle time of the winding operation section 58, whereby the operation rate of the winding apparatus can be increased to maximum. The method for forming the coil 7 using the winding apparatus shown in FIG. 18 can be applied in the same manner also in the other embodiments, and therefore will not repeatedly be described.

The insulator according to embodiment 1 configured as described above is an insulator of a stator of a rotating electric machine in which a plurality of divisional-coil-wound bodies are arranged in an annular shape, the divisional-coil-wound bodies each including a divisional core, the insulator provided to the divisional core, and a coil wound around the divisional core with the insulator interposed therebetween, the insulator including:
a first connection portion which is provided at one end in a circumferential direction on an outer side in a radial direction and which is to be connected to another said insulator adjacent in the circumferential direction; and
a second connection portion which is provided at another end in the circumferential direction on the outer side in the radial direction and which is to be connected to the first connection portion of another said insulator adjacent in the circumferential direction, wherein
the first connection portion and the second connection portion are structured by a snap-fit mechanism using elastic deformation,
a pair of the insulators adjacent in the circumferential direction and connected via the first connection portion and the second connection portion are rotatable relative to each other about rotation center axes in an axial direction of the first connection portion and the second connection portion, and
the rotation center axes are located on an inner side in the radial direction relative to an outer-circumferential surface on the outer side in the radial direction of the divisional core.

In the stator according to embodiment 1 configured as described above, each divisional core has a yoke portion extending in the circumferential direction and a tooth portion protruding toward the inner side in the radial direction from an inner-circumferential surface on the inner side in the radial direction of the yoke portion. One end in the circumferential direction of the yoke portion is formed in a convex shape. Another end in the circumferential direction of the yoke portion is formed in a concave shape. The convex shape and the concave shape have curved surfaces having the same radius of curvature.

The rotating electric machine according to embodiment 1 configured as described above includes: the above stator; and a rotor provided so as to be opposed to the stator with a gap in the radial direction therebetween.

Thus, the coil can be formed merely by connecting the first connection portion and the second connection portion, whereby the cost is reduced and the manufacturing process is simplified.

Further, in the insulator according to embodiment 1 configured as described above,
the first connection portion is formed by a columnar portion having a columnar shape, and the second connection portion is formed by an opening having a columnar-shaped surface to be engaged with the columnar portion.

Thus, connection between the first connection portion and the second connection portion is simplified.

Further, in the insulator according to embodiment 1 configured as described above,
each rotation-center axis is on a virtual plane extending in the axial direction at a middle in the circumferential direction between a pair of the divisional cores adjacent in the circumferential direction.

Thus, connection between the first connection portion and the second connection portion is facilitated.

Further, in the insulator according to embodiment 1 configured as described above,
the first connection portion has a first barb portion to be engaged with the second connection portion when the divisional-coil-wound bodies are arranged in an annular shape, and
the second connection portion has a second barb portion to be engaged with the first connection portion when the divisional-coil-wound bodies are arranged in an annular shape.

Thus, the annular shape of the divisional-coil-wound bodies can be assuredly retained by engagement between the first barb portion and the second barb portion.

Further, in the stator according to embodiment 1 configured as described above,
centers of curvature of the convex shape and the concave shape in a cross-section of the yoke portion along a direction perpendicular to the axial direction coincide with the rotation center axes of the first connection portion and the second connection portion.

Thus, the divisional cores and the insulators adjacent in the circumferential direction can be rotated about the rotation center axes.

Further, the stator according to embodiment 1 configured as described above includes a mold resin portion covering the divisional-coil-wound bodies.

Thus, roundness of the stator can be improved.

Further, the stator according to embodiment 1 configured as described above includes a frame applying a preload to outer-circumferential surfaces of the divisional-coil-wound bodies arranged in an annular shape toward the inner side in the radial direction.

Thus, roundness of the stator can be improved.

Further, in the rotating electric machine according to embodiment 1 configured as described above,
the first connection portions and the second connection portions of the divisional cores adjacent in the circumferential direction and provided with the insulators for a plural number not less than a number for forming the stator are connected, and then a magnet wire is continuously wound around the tooth portions with the insulators interposed therebetween by a flyer arm, to form the coils.

Thus, it is possible to efficiently wind a magnet wire around a plurality of the divisional cores with the insulators interposed therebetween.

Further, in the rotating electric machine according to embodiment 1 configured as described above,
one of the rotation-center axis of the first connection portion and the rotation-center axis of the second connection portion is located on an inner side in the circumferential direction relative to a circumferential-direction end surface of the divisional core, and the other rotation-center axis is located on an outer side in the circumferential direction relative to the circumferential-direction end surface of the divisional core.

Thus, the circumferential-direction end surfaces of the divisional cores on the outer side in the radial direction relative to the rotation center axes can contact with each other without forming any gaps, whereby a magnetic path is ensured and occurrence of magnetic saturation can be suppressed.

### Embodiment 2

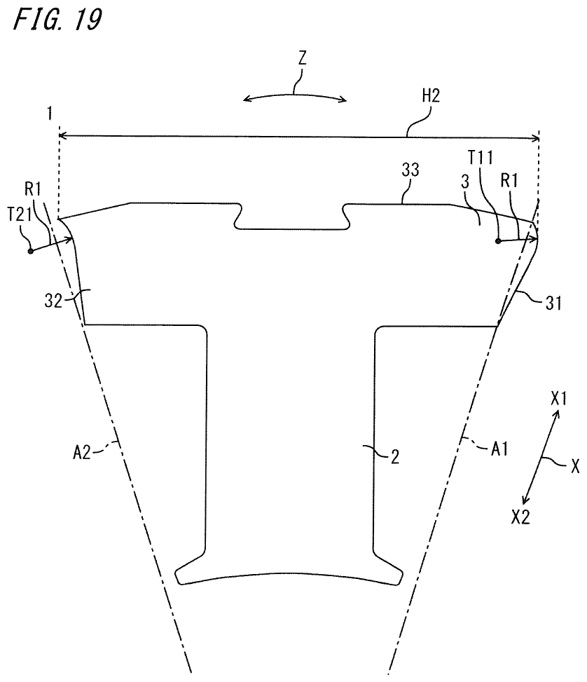

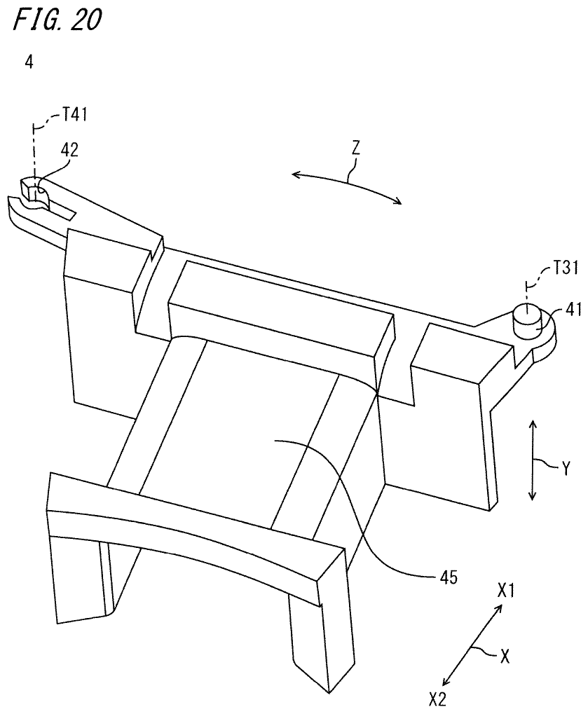

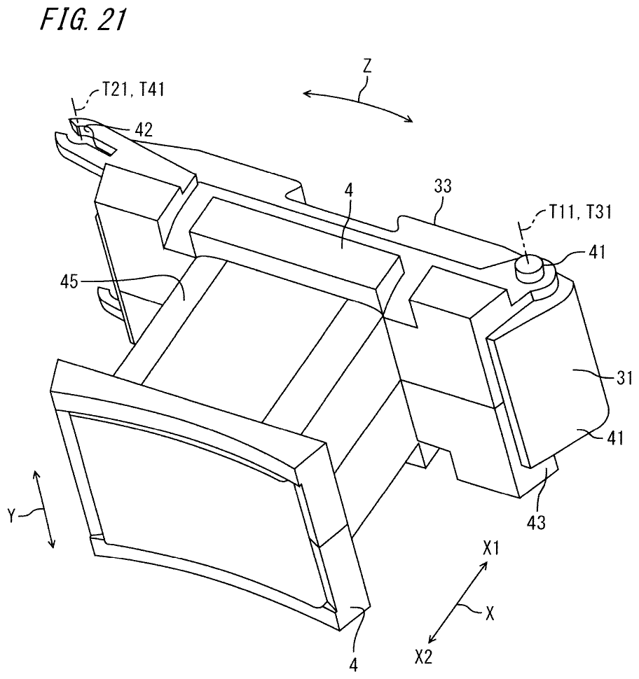

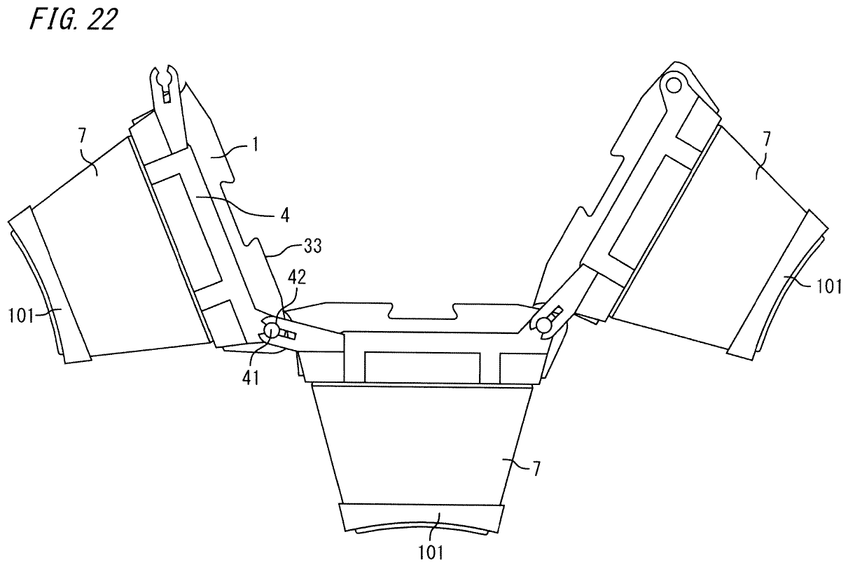

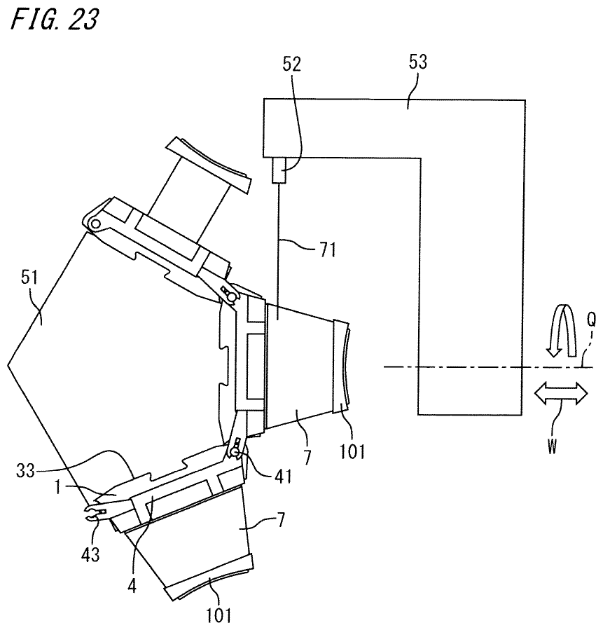

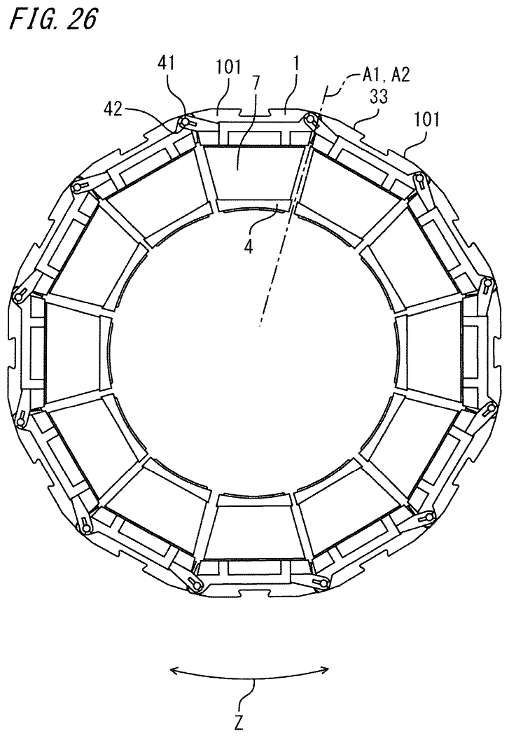

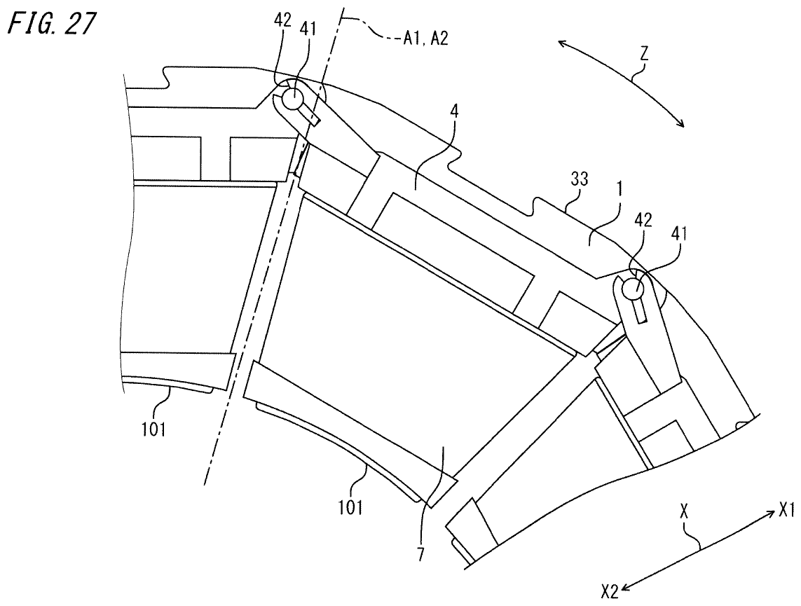

FIG. 19 is a plan view showing the structure of a divisional core according to embodiment 2. FIG. 20 is a perspective view showing the structure of an insulator to be provided to the divisional core shown in FIG. 19. FIG. 21 is a perspective view showing a structure in which the insulators shown in FIG. 20 are provided to the divisional core shown in FIG. 19. FIG. 22 is a plan view showing the structure of divisional-coil-wound bodies connected in the circumferential direction according to embodiment 2. FIG. 23 to FIG. 25 show methods for manufacturing the divisional-coil-wound bodies shown in FIG. 22. FIG. 26 shows a structure in which the divisional-coil-wound bodies shown in FIG. 23 to FIG. 25 are arranged in an annular shape. FIG. 27 is an enlarged view showing a part of the divisional-coil-wound bodies arranged in an annular shape shown in FIG. 26.

In the drawings, the same parts as those in the above embodiment 1 are denoted by the same reference characters and the description thereof is omitted. The present embodiment 2 and the above embodiment 1 are different in the positions of the first center axis T1, the second center axis T2, the first rotation-center axis T3, and the second rotation-center axis T4. The other parts are the same as those in the above embodiment 1, and therefore the difference from the above embodiment 1 will be mainly described here.

As shown in FIG. 19, the first contact portion 31 and the second contact portion 32 provided at both ends in the circumferential direction Z of the divisional core 1 have curved surfaces having the same radius R1 of curvature about a first center axis T11 and a second center axis T21 which are coaxial with a first rotation-center axis T31 and a second rotation-center axis T41 and which are separate in the circumferential direction Z from the virtual planes A1 and A2 between the divisional cores 1 adjacent in the circumferential direction Z. Since the first center axis T11 is shifted in the circumferential direction Z from the first center axis T1 of the above embodiment 1, sharp parts of corners on the outer circumferential side of the convex shape and the concave shape of the first contact portion 31 and the second contact portion 32 are made milder, whereby wear of a mold for manufacturing the divisional core 1 can be suppressed.

In addition, a width H2 in the circumferential direction Z of the yoke portion 3 of the divisional core 1 can be made smaller than a width H1 (see FIG. 1) in the above embodiment 1. Therefore, in a case of manufacturing the divisional core 1 by stamping and stacking steel sheets, the amount of material to be used can be reduced, so that the cost is reduced. In addition, in a case of performing a stamping process, since the length of the entire perimeter of the divisional core 1 can be shortened as compared to the above embodiment 1, a stamping load is reduced, so that the cost is reduced.

As shown in FIG. 20, the insulator 4 of embodiment 2 is formed such that the first rotation-center axis T31 of the columnar portion 41 and the second rotation-center axis T41 of the opening 42 are coaxial with the first center axis T11 or the second center axis T21. Therefore, the first rotation-center axis T31 and the second rotation-center axis T41 are respectively shifted from the virtual plane A1 and A2, as compared to FIG. 2 in the above embodiment 1. Here, shapes corresponding to the first barb portion 43 and the second barb portion 44 of the above embodiment 1 are omitted, but similar shapes may be added.

Then, as shown in FIG. 21, the insulators 4 are attached to the divisional core 1. Then, as shown in FIG. 22, the columnar portions 41 and the openings 42 of the insulators 4 of the divisional cores 1 are connected, and the divisional cores 1 can be rotated about the first center axes T11 in the direction in which the tooth portions 2 are opened. Thus, by appropriately designing the shapes of the first contact portion 31 and the second contact portion 32 at both ends in the circumferential direction Z of the yoke portion 3 of the divisional core 1, the tooth portions 2 can be moved away to positions that do not interfere with the flyer arm 53 and the nozzle 52, as shown in FIG. 23.

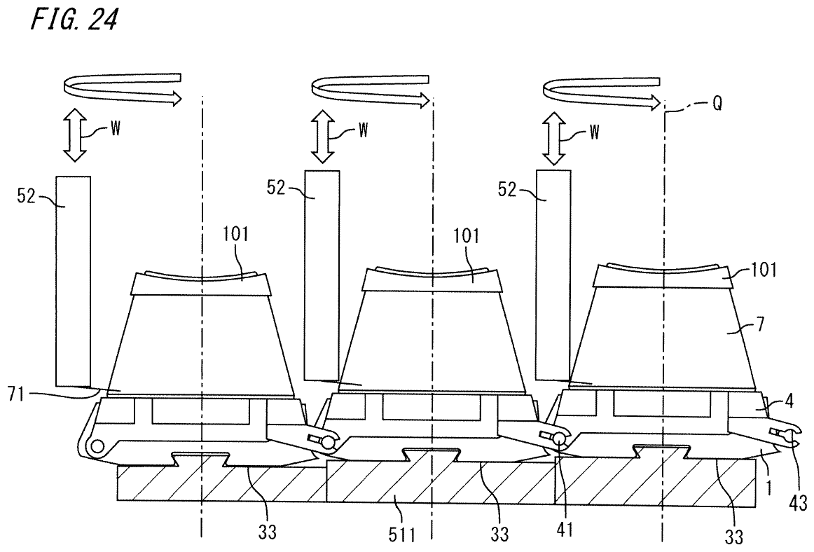

As shown in FIG. 24, the divisional cores 1 may be retained by a chuck portion 511 having seat surfaces stepped in the radial direction X, whereby the magnet wires 71 can be wound in the same manner as in FIG. 8 in the above embodiment 1.

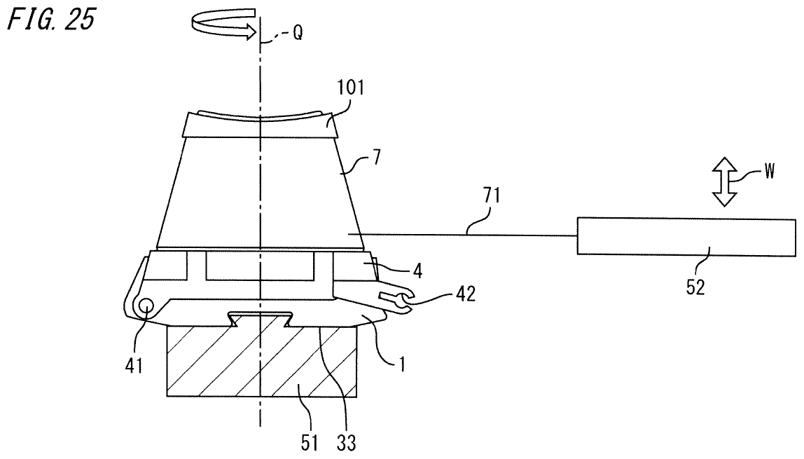

As shown in FIG. 25, before the columnar portions 41 and the openings 42 of the insulators 4 of the divisional cores 1 are connected, the magnet wire 71 may be wound to form the coil 7.

The divisional-coil-wound bodies 101 formed as described above can be assembled in an annular shape as in the above embodiment 1, as shown in FIG. 26 and FIG. 27.

With the insulator, the stator, the rotating electric machine, and the method for manufacturing the stator according to embodiment 2 configured as described above, the same effects as in the above embodiment 1 are provided, and in addition,
each rotation-center axis is separate in the circumferential direction from a virtual plane extending in the axial direction at a middle in the circumferential direction between a pair of the divisional cores adjacent in the circumferential direction.

Thus, the sizes of the divisional cores can be reduced, whereby the cost is further reduced.

### Embodiment 3

In the above embodiments, a case where the columnar portion 41 is formed in a circular column shape and the opening 42 is formed in a shape having a circular-column-shaped surface, has been shown, but the shapes are not limited thereto. In the present embodiment 3, a columnar portion 411 or a columnar portion 412 of the insulator 4 is formed in a polygonal column shape or a circular column shape provided with a recess/projection. Accordingly, the inner surface of an opening 421 or an opening 422 along the columnar portion 411 or the columnar portion 412 is formed as a polygonal-column-shaped surface or a circular-column-shaped surface provided with a recess/projection. The other structures are the same as those in the above embodiments and therefore the description thereof is omitted as appropriate.

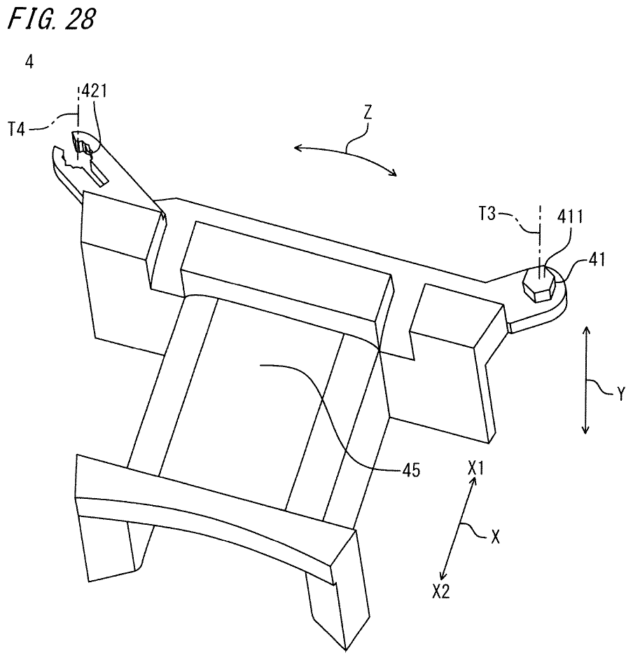

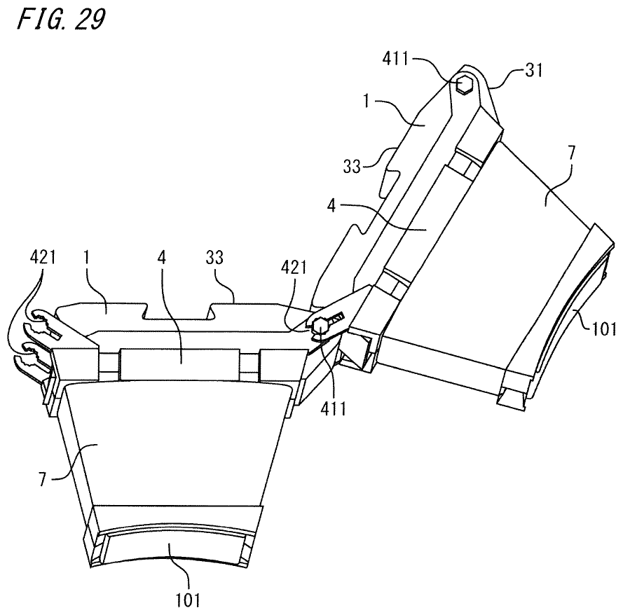

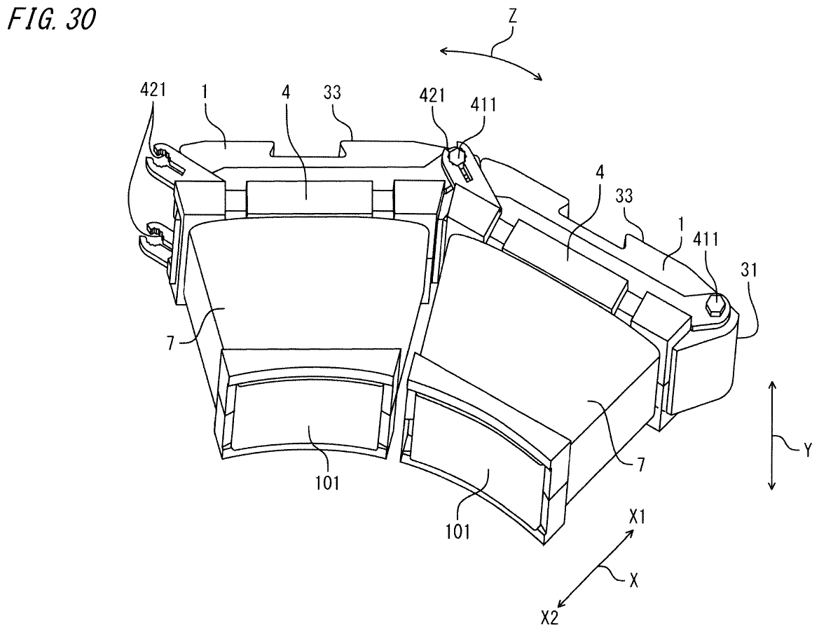

FIG. 28 to FIG. 30 show a case where the columnar portion 411 of the insulator 4 is formed in a polygonal column shape, here, a hexagonal column shape, and the inner surface of the opening 422 along the columnar portion 411 is formed in a polygonal-column-shaped surface, here, a hexagonal-columnar-shaped surface. FIG. 28 is a perspective view showing the structure of the insulator 4. FIG. 29 and FIG. 30 are perspective views showing the structure of the divisional-coil-wound bodies 101 with the columnar portion 411 and the opening 421 of the insulators 4 connected to each other. FIG. 29 shows a state when the coils 7 of the divisional-coil-wound bodies 101 are formed, and FIG. 30 shows a state when an annular shape is formed after the coils 7 of the divisional-coil-wound bodies 101 are formed. The hexagonal shape is merely an example, and even in a case of another polygonal column shape, the same structure and the same operation can be applied.

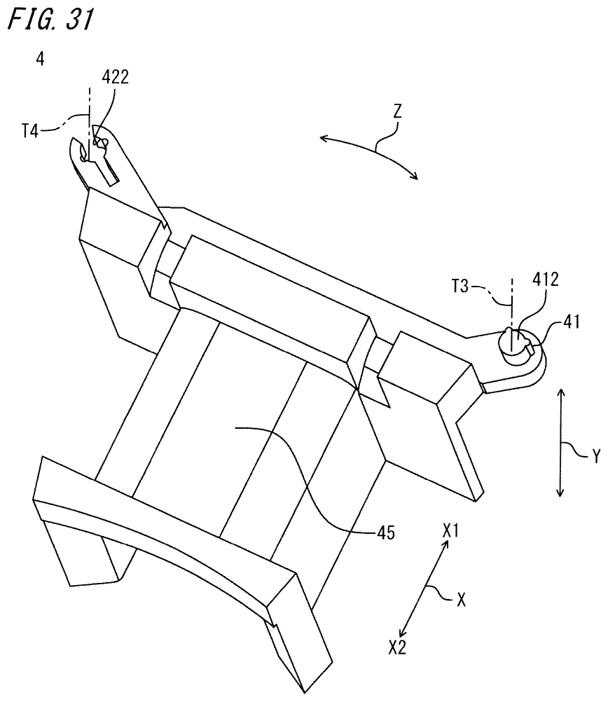

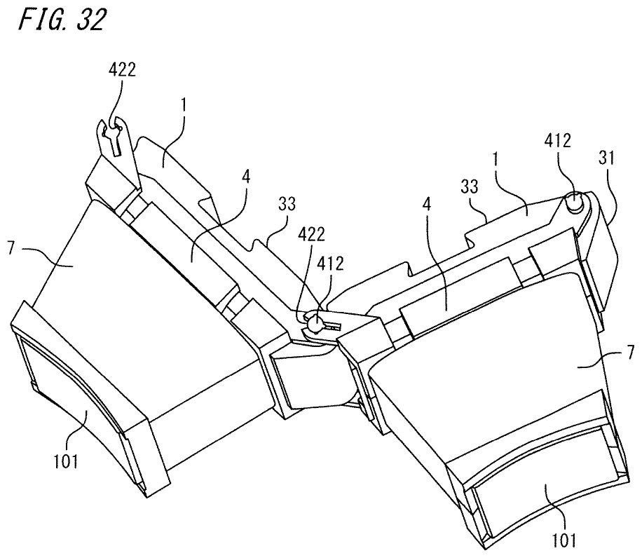

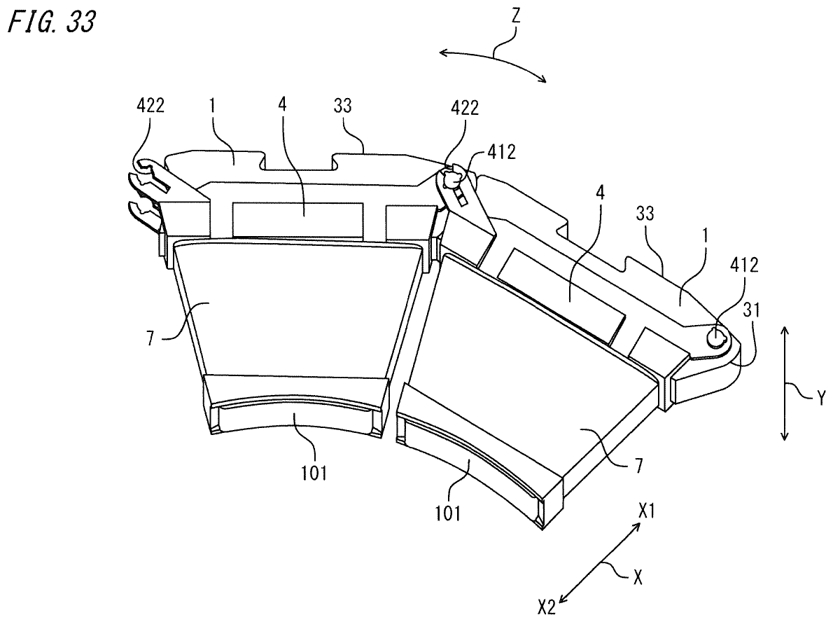

FIG. 31 to FIG. 33 show a case where the columnar portion 412 of the insulator 4 is formed in a circular column shape provided with two projections, and the inner surface of the opening 422 along the columnar portion 412 is formed as a circular-column-shaped surface having two recesses. FIG. 31 is a perspective view showing the structure of the insulator 4. FIG. 32 and FIG. 33 are perspective views showing the structure of the divisional-coil-wound bodies 101 with the columnar portion 412 and the opening 422 of the insulators 4 connected to each other. FIG. 32 shows a state when the coils 7 of the divisional-coil-wound bodies 101 are formed, and FIG. 33 shows a state when an annular shape is formed after the coils 7 of the divisional-coil-wound bodies 101 are formed. The two recesses/projections are merely an example, and even in a case of a different number of recesses/projections, the same structure and the same operation can be applied.

Owing to the above shapes, a resistive force is produced by the polygonal column or the recesses and the projections when the insulators 4 and the divisional cores 1 are rotated about the first rotation-center axis T3 (second rotation-center axis T4). The dimensions are set such that maximum strain produced at the columnar portion 411, 412 and the opening 421, 422 when rotation is performed with a force greater than the resistive force does not become greater than breaking strain of the material of the insulator 4. Thus, by applying a force greater than a resistive force against rotation so as to elastically deform the insulators 4, rotation can be performed about the first center axis T1, and the rotation is stopped intermittently by the polygonal column or the recesses and the projections. Since the rotation can be stopped intermittently, the posture of the divisional-coil-wound bodies 101 during transportation between processes and when they are assembled in an annular shape is stabilized.

With the insulator, the stator, the rotating electric machine, and the method for manufacturing the stator according to embodiment 3 configured as described above, the same effects as in the above embodiments are provided, and in addition,
the columnar portion of the connection portion is formed in a polygonal column shape or a shape obtained by providing a recess/projection to a circular column.

Thus, rotation can be stopped intermittently with connection between the columnar portion and the opening of the insulators, whereby the posture of the divisional-coil-wound bodies is stabilized during transportation and when they are assembled in an annular shape, so that the manufacturing process can be simplified.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure.

For example, at least one of the constituent components may be modified, added, or eliminated. At least one of the constituent components mentioned in at least one of the preferred embodiments may be selected and combined with the constituent components mentioned in another preferred embodiment.

Hereinafter, modes of the present disclosure are summarized as additional notes.

### Additional Note 1

An insulator of a stator of a rotating electric machine in which a plurality of divisional-coil-wound bodies are arranged in an annular shape, the divisional-coil-wound bodies each including a divisional core, the insulator provided to the divisional core, and a coil wound around the divisional core with the insulator interposed therebetween, the insulator comprising:
a first connection portion which is provided at one end in a circumferential direction on an outer side in a radial direction and which is to be connected to another said insulator adjacent in the circumferential direction; and
a second connection portion which is provided at another end in the circumferential direction on the outer side in the radial direction and which is to be connected to the first connection portion of another said insulator adjacent in the circumferential direction, wherein
the first connection portion and the second connection portion are structured by a snap-fit mechanism using elastic deformation,
a pair of the insulators adjacent in the circumferential direction and connected via the first connection portion and the second connection portion are rotatable relative to each other about rotation center axes in an axial direction of the first connection portion and the second connection portion, and
the rotation center axes are located on an inner side in the radial direction relative to an outer-circumferential surface on the outer side in the radial direction of the divisional core.

### Additional Note 2

The insulator according to additional note 1, wherein
the first connection portion is formed by a columnar portion having a columnar shape, and
the second connection portion is formed by an opening having a columnar-shaped surface to be engaged with the columnar portion.

### Additional Note 3

The insulator according to additional note 2, wherein
the columnar portion of the first connection portion is formed in a polygonal column shape or a shape obtained by providing a recess/projection to a circular column.

### Additional Note 4

The insulator according to any one of additional notes 1 to 3, wherein
each rotation-center axis is on a virtual plane extending in the axial direction at a middle in the circumferential direction between a pair of the divisional cores adjacent in the circumferential direction.

### Additional Note 5

The insulator according to any one of additional notes 1 to 3, wherein
each rotation-center axis is separate in the circumferential direction from a virtual plane extending in the axial direction at a middle in the circumferential direction between a pair of the divisional cores adjacent in the circumferential direction.

### Additional Note 6

The insulator according to any one of additional notes 1 to 4, wherein
the first connection portion has a first barb portion to be engaged with the second connection portion when the divisional-coil-wound bodies are arranged in an annular shape, and
the second connection portion has a second barb portion to be engaged with the first connection portion when the divisional-coil-wound bodies are arranged in an annular shape.

### Additional Note 7

The stator having the insulator according to any one of additional notes 1 to 6, wherein
each divisional core has a yoke portion extending in the circumferential direction and a tooth portion protruding toward the inner side in the radial direction from an inner-circumferential surface on the inner side in the radial direction of the yoke portion,
one end in the circumferential direction of the yoke portion is formed in a convex shape,
another end in the circumferential direction of the yoke portion is formed in a concave shape, and
the convex shape and the concave shape have curved surfaces having the same radius of curvature.

### Additional Note 8

The stator according to additional note 7, wherein
centers of curvature of the convex shape and the concave shape in a cross-section of the yoke portion along a direction perpendicular to the axial direction coincide with the rotation center axes of the first connection portion and the second connection portion.

### Additional Note 9

The stator according to additional note 7 or 8, comprising a mold resin portion covering the divisional-coil-wound bodies.

### Additional Note 10

The stator according to additional note 7 or 8, comprising a frame applying a preload to outer-circumferential surfaces of the divisional-coil-wound bodies arranged in an annular shape toward the inner side in the radial direction.

### Additional Note 11

A rotating electric machine comprising:
the stator according to any one of additional notes 7 to 10; and
a rotor provided so as to be opposed to the stator with a gap in the radial direction therebetween.

### Additional Note 12

A method for manufacturing the stator according to any one of additional notes 7 to 11, wherein
the first connection portions and the second connection portions of the divisional cores adjacent in the circumferential direction and provided with the insulators for a plural number not less than a number for forming the stator are connected, and then a magnet wire is continuously wound around the tooth portions with the insulators interposed therebetween by a flyer arm, to form the coils.

### DESCRIPTION OF THE REFERENCE CHARACTERS

1 divisional core
100 rotating electric machine
101 divisional-coil-wound body
11 rotor
12 stator
13 shaft
14 bracket
15 bearing
16 frame
2 tooth portion
3 yoke portion
31 first contact portion
32 second contact portion
33 outer-circumferential surface
4 insulator
41 columnar portion
411 columnar portion
412 columnar portion
42 opening
421 opening
422 opening
43 first barb portion
44 second barb portion
45 winding portion
51 chuck portion
511 chuck portion
52 nozzle
53 flyer arm
55 discharge section
56 wire bobbin
57 tensioner
58 winding operation section
59 feeding section
6 mold resin portion
7 coil
71 magnet wire
A1 first virtual plane
A2 second virtual plane
F1 direction
F2 direction
G arrow
H1 width
H2 width
T1 first center axis
T11 first center axis
T2 second center axis
T21 second center axis
T3 first rotation-center axis
T31 first rotation-center axis
T4 second rotation-center axis
T41 second rotation-center axis
R radius of curvature
R1 radius of curvature
W swing direction
X radial direction
X1 outer side
X2 inner side
Y axial direction
Z circumferential direction
Q rotation axis

1. An insulator of a stator of a rotating electric machine in which a plurality of divisional-coil-wound bodies are arranged in an annular shape, the divisional-coil-wound bodies each including a divisional core, the insulator provided to the divisional core, and a coil wound around the divisional core with the insulator interposed therebetween, the insulator comprising:
a first connection portion which is provided at one end in a circumferential direction on an outer side in a radial direction and which is to be connected to another said insulator adjacent in the circumferential direction; and
a second connection portion which is provided at another end in the circumferential direction on the outer side in the radial direction and which is to be connected to the first connection portion of another said insulator adjacent in the circumferential direction, wherein
the first connection portion and the second connection portion are structured by a snap-fit mechanism using elastic deformation,
a pair of the insulators adjacent in the circumferential direction and connected via the first connection portion and the second connection portion are rotatable relative to each other about rotation center axes in an axial direction of the first connection portion and the second connection portion,
the rotation center axes are located on an inner side in the radial direction relative to an outer-circumferential surface on the outer side in the radial direction of the divisional core,
one of the rotation-center axis of the first connection portion and the rotation-center axis of the second connection portion is located on an inner side in the circumferential direction relative to a circumferential-direction end surface of the divisional core, and the other rotation-center axis is located on an outer side in the circumferential direction relative to the circumferential-direction end surface of the divisional core, and
between side surfaces opposed to each other in the circumferential direction, of a pair of the insulators connected via the first connection portion and the second connection portion, a gap is formed so that the circumferential-direction end surfaces of the divisional cores connected by the pair of insulators contact with each other when closed in an annular shape.

2. (canceled)

3. The insulator according to claim 1, wherein
the first connection portion is formed by a columnar portion having a columnar shape, and
the second connection portion is formed by an opening having a columnar-shaped surface to be engaged with the columnar portion.

4. The insulator according to claim 3, wherein
the columnar portion of the first connection portion is formed in a polygonal column shape or a shape obtained by providing a recess/projection to a circular column.

5. The insulator according to claim 1, wherein
each rotation-center axis is on a virtual plane extending in the axial direction at a middle in the circumferential direction between a pair of the divisional cores adjacent in the circumferential direction.

6. The insulator according to claim 1, wherein
the one rotation-center axis is separate, toward a side opposite in the circumferential direction to the circumferential-direction end surface of the divisional core from a virtual plane extending in the axial direction at a middle in the circumferential direction between a pair of the divisional cores adjacent in the circumferential direction, and
the other rotation-center axis is separate, toward a side opposite in the circumferential direction to the circumferential-direction end surface of the divisional core, from the virtual plane.

7. The insulator according to claim 1, wherein
the first connection portion has a first barb portion to be engaged with the second connection portion when the divisional-coil-wound bodies are arranged in an annular shape, and
the second connection portion has a second barb portion to be engaged with the first connection portion when the divisional-coil-wound bodies are arranged in an annular shape.

8. The stator having the insulator according to claim 1, wherein
each divisional core has a yoke portion extending in the circumferential direction and a tooth portion protruding toward the inner side in the radial direction from an inner-circumferential surface on the inner side in the radial direction of the yoke portion,
one end in the circumferential direction of the yoke portion is formed in a convex shape,
another end in the circumferential direction of the yoke portion is formed in a concave shape, and
the convex shape and the concave shape have curved surfaces having the same radius of curvature.

9. The stator according to claim 8, wherein
centers of curvature of the convex shape and the concave shape in a cross-section of the yoke portion along a direction perpendicular to the axial direction coincide with the rotation center axes of the first connection portion and the second connection portion.

10. The stator according to claim 8, comprising a mold resin portion covering the divisional-coil-wound bodies.

11. The stator according to claim 8, comprising a frame applying a preload to outer-circumferential surfaces of the divisional-coil-wound bodies arranged in an annular shape toward the inner side in the radial direction.

12. A rotating electric machine comprising:
the stator according to claim 8; and
a rotor provided so as to be opposed to the stator with a gap in the radial direction therebetween.

13. A method for manufacturing the stator according to claim 8, wherein
the first connection portions and the second connection portions of the divisional cores adjacent in the circumferential direction and provided with the insulators for a plural number not less than a number for forming the stator are connected, and then a magnet wire is continuously wound around the tooth portions with the insulators interposed therebetween by a flyer arm, to form the coils.

14. The stator according to claim 8, wherein
a center of curvature of the convex shape in a cross-section of the yoke portion along a direction perpendicular to the axial direction is separate, toward a side opposite in the circumferential direction to a circumferential-direction end surface of the convex shape, from a virtual plane extending in the axial direction at a middle in the circumferential direction between a pair of the divisional cores adjacent in the circumferential direction, and
a center of curvature of the concave shape in the cross-section of the yoke portion along the direction perpendicular to the axial direction is separate, toward a side opposite in the circumferential direction to a circumferential-direction end surface of the concave shape, from the virtual plane.

15. The insulator according to claim 3, wherein
each rotation-center axis is on a virtual plane extending in the axial direction at a middle in the circumferential direction between a pair of the divisional cores adjacent in the circumferential direction.

16. The insulator according to claim 4, wherein
each rotation-center axis is on a virtual plane extending in the axial direction at a middle in the circumferential direction between a pair of the divisional cores adjacent in the circumferential direction.

17. The insulator according to claim 3, wherein
the one rotation-center axis is separate, toward a side opposite in the circumferential direction to the circumferential-direction end surface of the divisional core, from a virtual plane extending in the axial direction at a middle in the circumferential direction between a pair of the divisional cores adjacent in the circumferential direction, and
the other rotation-center axis is separate, toward a side opposite in the circumferential direction to the circumferential-direction end surface of the divisional core, from the virtual plane.

18. The insulator according to claim 4, wherein
the one rotation-center axis is separate, toward a side opposite in the circumferential direction to the circumferential-direction end surface of the divisional core, from a virtual plane extending in the axial direction at a middle in the circumferential direction between a pair of the divisional cores adjacent in the circumferential direction, and
the other rotation-center axis is separate, toward a side opposite in the circumferential direction to the circumferential-direction end surface of the divisional core, from the virtual plane.

19. The insulator according to claim 3, wherein
the first connection portion has a first barb portion to be engaged with the second connection portion when the divisional-coil-wound bodies are arranged in an annular shape, and
the second connection portion has a second barb portion to be engaged with the first connection portion when the divisional-coil-wound bodies are arranged in an annular shape.

20. The insulator according to claim 4, wherein
the first connection portion has a first barb portion to be engaged with the second connection portion when the divisional-coil-wound bodies are arranged in an annular shape, and
the second connection portion has a second barb portion to be engaged with the first connection portion when the divisional-coil-wound bodies are arranged in an annular shape.

21. The insulator according to claim 5, wherein
the first connection portion has a first barb portion to be engaged with the second connection portion when the divisional-coil-wound bodies are arranged in an annular shape, and
the second connection portion has a second barb portion to be engaged with the first connection portion when the divisional-coil-wound bodies are arranged in an annular shape.
